(19) United States
(12) Patent Application Publication
(10) Pub. No.: US 2012/0199698 A1
(43) Pub. Date: Aug. 9, 2012

(54) UNMANNED AIR VEHICLE (UAV), CONTROL SYSTEM AND METHOD

(75) Inventors: Peter Geoffrey THOMASSON, Cranfield (GB); Robert Idris JONES, Cranfield (GB); David Ian Alistair POLL, Cranfield (GB)

(73) Assignee: CRANFIELD AEROSPACE LTD, Bedfordshire (GB)

(21) Appl. No.: 13/226,179

(22) Filed: Sep. 6, 2011

Related U.S. Application Data
(63) Continuation of application No. PCT/GB2010/000399, filed on Mar. 5, 2010.

(30) Foreign Application Priority Data
Mar. 5, 2009 (GB) 0903812.6

(51) Int. Cl. G05D 1/00; G08G 5/04; B64C 13/16

(52) U.S. Cl. 244/175; 244/76 C

(57) ABSTRACT

A gust-insensitive unmanned air vehicle (UAV) for imaging the ground, comprising a substantially neutrally stable air frame having a fuselage and at least three wings which include control surfaces. The wings are arranged in symmetrical relation about the fuselage and confer the UAV with a roll stability about a longitudinal axis of the fuselage for any roll angle. The UAV also includes a propulsion device for propelling the UAV in flight, an image sensor for imaging the ground, and a flight control system for controlling the in-flight operation of the UAV. The flight control system includes flight control sensors and is operative to render the UAV gust insensitive in response to inputs from the flight control sensors.

The present invention relates to an unmanned air vehicle (UAV), and a control system for and method of controlling the same.

The present invention alms to provide a robust UAV for imaging ground-level objects, in particular a lightweight UAV for low-level operation.

Such vehicles must be capable of conducting operations in adverse weather conditions, including strong winds and gusts.

For traditional, stable aircraft, where the center of gravity is ahead of the aerodynamic center, an encounter with a general wind gust will result in a rotational displacement of the vehicle in any or all of the three rotational axes of roll, pitch and yaw.

If an image sensor were fixed rigidly to the structure of such a traditional, stable aircraft, the pitching, rolling and yawing motions induced as the aircraft moves through wind gusts would be such that the sensor axis would be displaced for the point of interest, the ground-based object, and the image would shake as the aircraft is returned to its original orientation by virtue of its inherent stability. This could result in the loss of the image of the ground-based object or in an image which is shaking so much that it cannot be used by a ground-based operator.

In existing vehicles, this problem is solved by mounting the imaging image sensor in a complex gimbal system, which attempts to isolate the aiming and motion of the image sensor from the motion of the UAV.

This system, whilst effective, is mechanically complex, which is expensive, heavier and more susceptible to failure in use and during handling.

In another aspect the present invention provides object position determination and trajectory shaping to provide sensor guidance command, as opposed to airframe positional command.

In a further aspect the present invention provides a sense-and-avoid capability through smart sensor integration, airframe agility and remote piloting. This sense-and-avoid capability should enable operation of an unmanned air vehicle in non-segregated airspace, particularly in the UK.

In one embodiment the present invention provides a gust-insensitive unmanned air vehicle (UAV) for imaging the ground, the UAV comprising: an airframe which is substantially neutrally stable and comprises a fuselage and at least three wings which include control surfaces, wherein the wings are arranged in symmetrical relation about the fuselage and confer the UAV with a roll stability about the longitudinal axis of the fuselage for any roll angle, thereby allowing the roll angle of the UAV to be set to any required angle independent of the heading and pitch angle of the UAV; a propulsion device for propelling the UAV in flight; an image sensor for imaging the ground, wherein the image sensor has a footprint, the position of which is determined by the roll angle of the UAV; and a flight control system for controlling the in-flight operation of the UAV, wherein the flight control system includes flight control sensors and is operative to render the UAV gust insensitive in response to inputs from the flight control sensors, whereby the UAV exhibits substantially only linear displacements in response to wind gusts, and control the roll angle of the UAV to determine the position of the sensor footprint.

The present invention also extends to an unmanned air vehicle (UAV) control system for imaging the ground, the UAV control system comprising: the above-described UAV, further comprising: a communications module for communicating with a ground station; and a ground station for controlling operation of the UAV, wherein the ground station comprises: a communications module for communicating with the UAV; and a ground control system for controlling operation of the UAV.

In another embodiment the present invention provides an unmanned air vehicle (UAV) for imaging the ground, the UAV comprising: an airframe which comprises a fuselage and at least three wings which include control surfaces, wherein the wings are arranged in symmetrical relation about the fuselage and confer the UAV with a roll stability about a longitudinal axis of the fuselage for any roll angle, thereby allowing the roll angle of the UAV to be set to any required angle independent of the heading and pitch angle of the UAV; a propulsion device for propelling the UAV in flight; an image sensor for imaging the ground, wherein the image sensor has a footprint, the position of which is determined by the roll angle of the UAV; and a flight control system for controlling the in-flight operation of the UAV, wherein the flight control system includes flight control sensors and is operative to control the roll angle of the UAV to determine the position of the sensor footprint.

In a further embodiment the present invention provides a gust-Insensitive unmanned air vehicle (UAV) for imaging the ground, the UAV comprising: an airframe which is neutrally stable and comprises a fuselage and wings which include control surfaces; a propulsion device for propelling the UAV in flight; an image sensor for imaging the ground, wherein the image sensor has a footprint, the position of which is determined by the orientation of the UAV; and a flight control system for controlling the in-flight operation of the UAV, wherein the flight control system includes flight control sensors and is operative to render the UAV gust insensitive in response to inputs from the flight control sensors, whereby the UAV exhibits substantially only linear displacements in response to wind gusts.

In a still further embodiment the present invention provides an unmanned air vehicle (UAV) control system for imaging the ground, the UAV control system comprising: an unmanned air vehicle (UAV) including an image sensor for imaging the ground, the image sensor having a footprint, the position of which is determined by the orientation of the UAV, and a communications module for communicating with a ground station; and a ground station for controlling operation of the UAV, the ground station comprising a communications module for communicating with the UAV, and a ground control system for controlling operation of the UAV.

In a yet further embodiment the present invention provides a method of imaging the ground using an unmanned air vehicle (UAV), the method comprising the steps of: providing an unmanned air vehicle (UAV) including an image sensor for imaging the ground, the image sensor having a footprint, the position of which is determined by the orientation of the UAV; and navigating the UAV to image the ground.

In a still yet further embodiment the present invention provides a method of operating an unmanned air vehicle (UAV), the method comprising the steps of: providing an unmanned air vehicle (UAV), wherein the UAV has an airframe which is substantially neutrally stable and comprises a fuselage and at least three wings which include control surfaces, wherein the wings are arranged in symmetrical relation about the fuselage and confer the UAV with a roll stability about the longitudinal axis of the fuselage for any roll angle, thereby allowing the roll angle of the UAV to be set to any required angle independent of the heading and pitch angle of the UAV, and comprising a flight control system for controlling the in-flight operation of the UAV, wherein the flight control system includes flight control sensors and a proximity sensor for sensing proximity of physical structures, through or around which the UAV is to be navigated; and automatically navigating the UAV utilizing control inputs from the flight control sensors and the proximity sensor, preferably at a fixed height, and rendering the UAV gust insensitive in response to inputs from the flight control sensors, whereby the UAV exhibits substantially only linear displacements in response to wind gusts.

Preferred embodiments of the present invention will now be described hereinbelow by way of example only with reference to the accompanying drawings, in which:

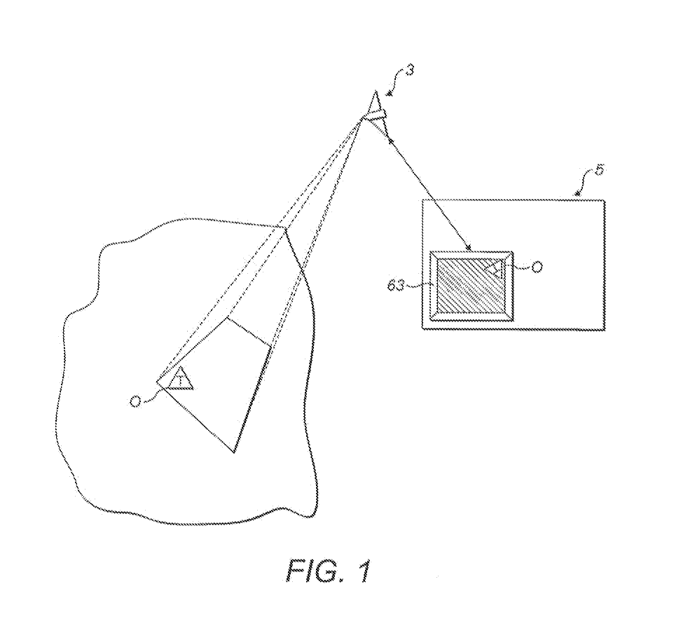

FIG. 1 illustrates an unmanned air vehicle (UAV) control system in accordance with a first embodiment of the present invention;

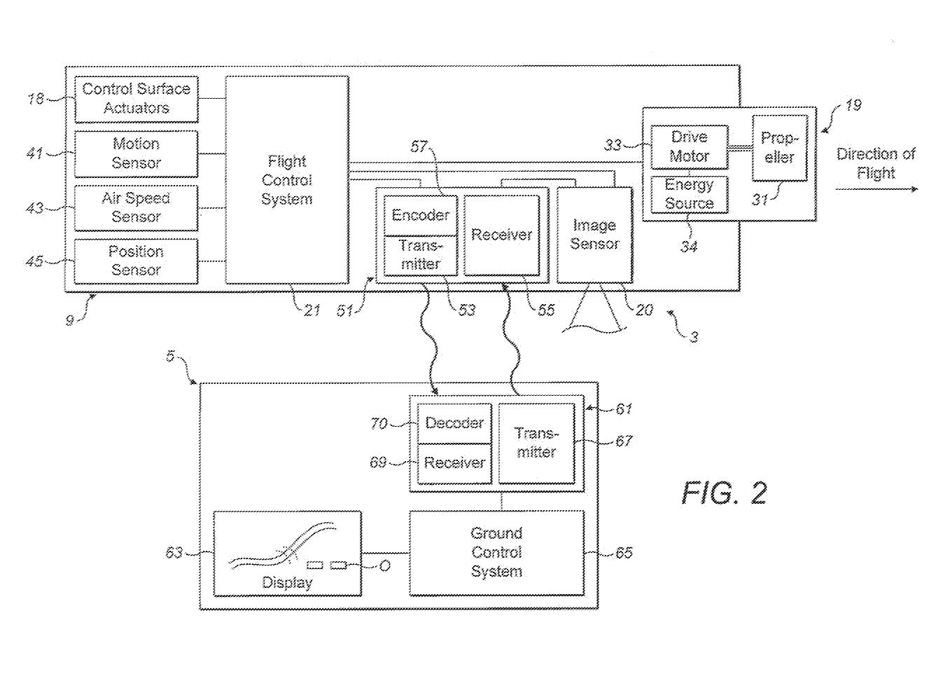

FIG. 2 schematically represents the UAV and the ground station of the UAV control system of FIG. 1;

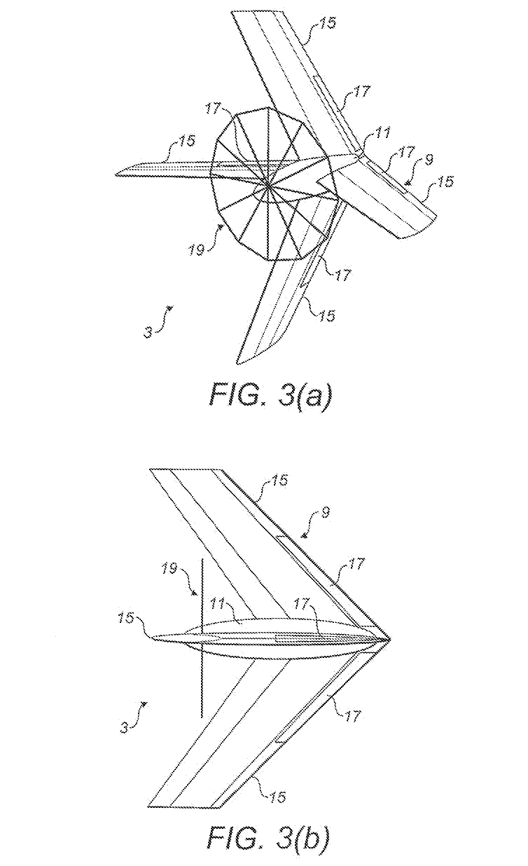

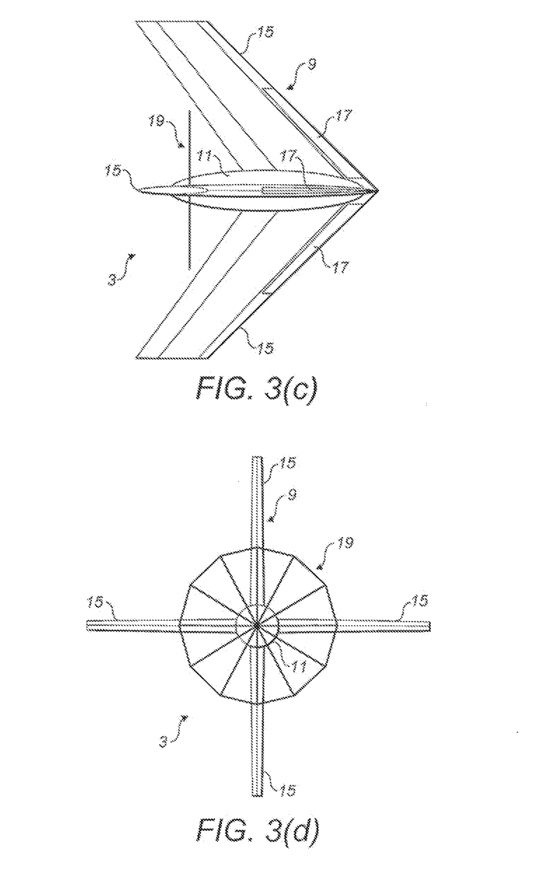

FIGS. 3(a) to (d) illustrate front perspective, side, plan and front views of a UAV in accordance with a preferred embodiment of the present invention;

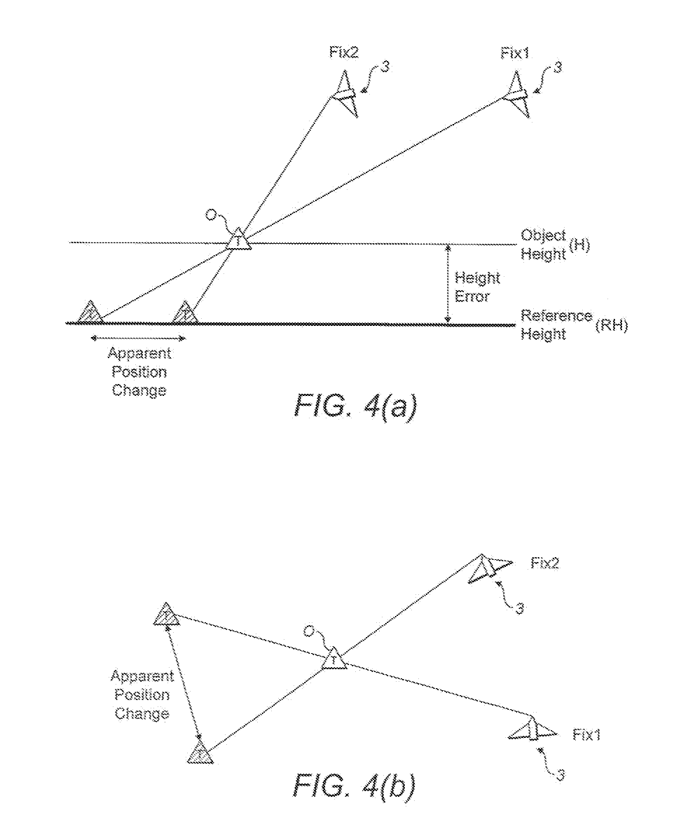

FIGS. 4(a) and (b) illustrate the position determining technology employed by the UAV control system of FIG. 1, where (a) the UAV is on a track approaching an object O, and (b) the UAV is moving radially with respect to the object O;

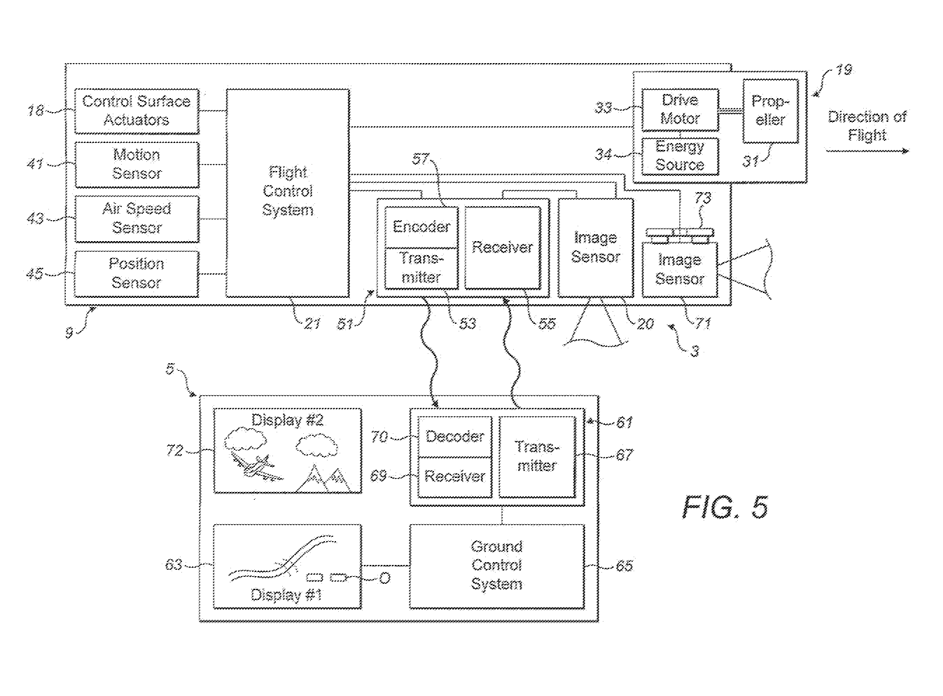

FIG. 5 schematically represents the UAV and the ground station of a UAV control system as a modification of the UAV control system of FIG. 1;

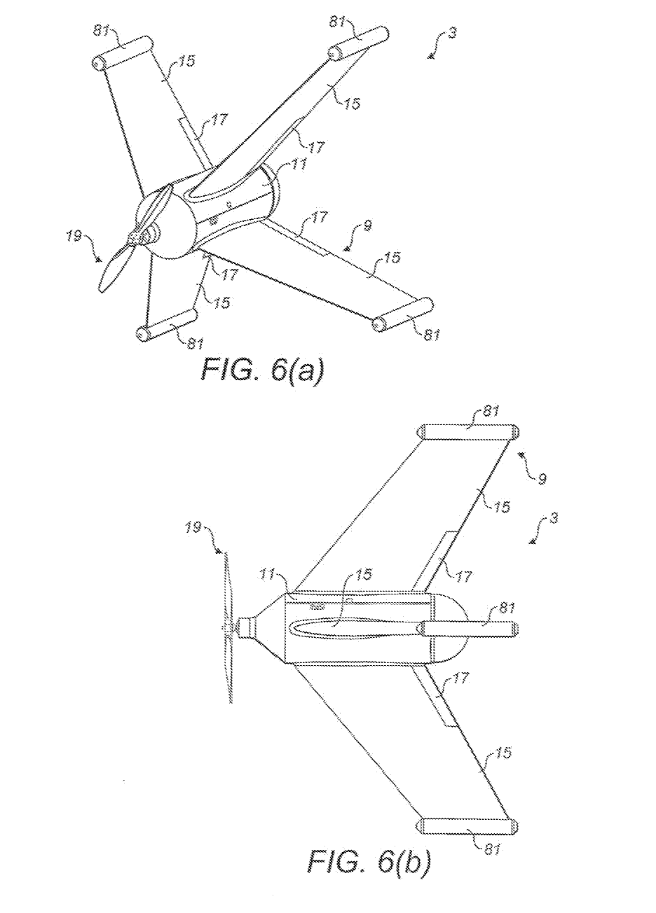

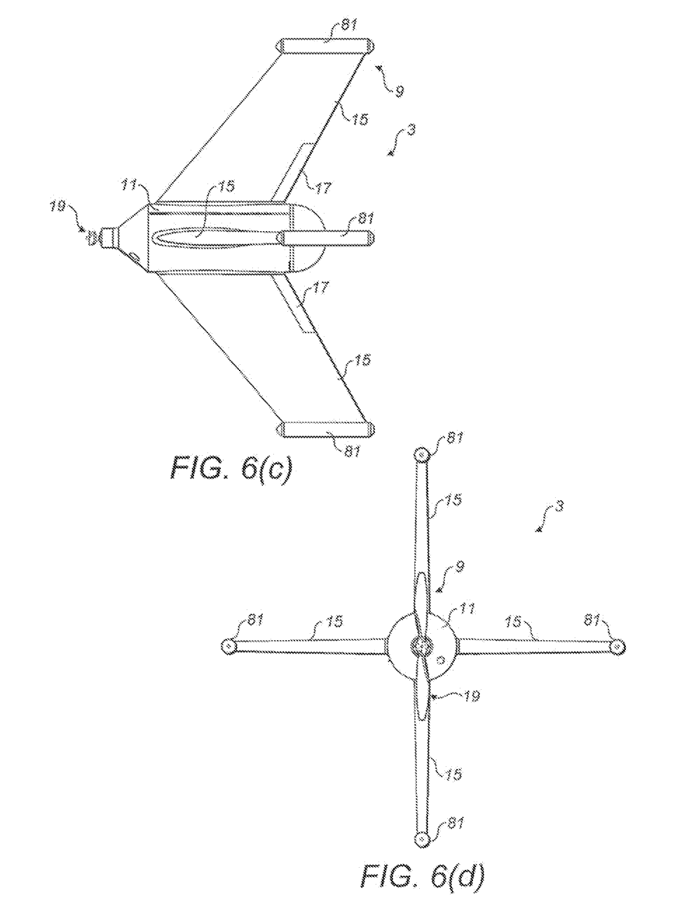

FIGS. 6(a) to (d) illustrate front perspective, side, plan and front views of a UAV in accordance with a second embodiment of the preset invention; and

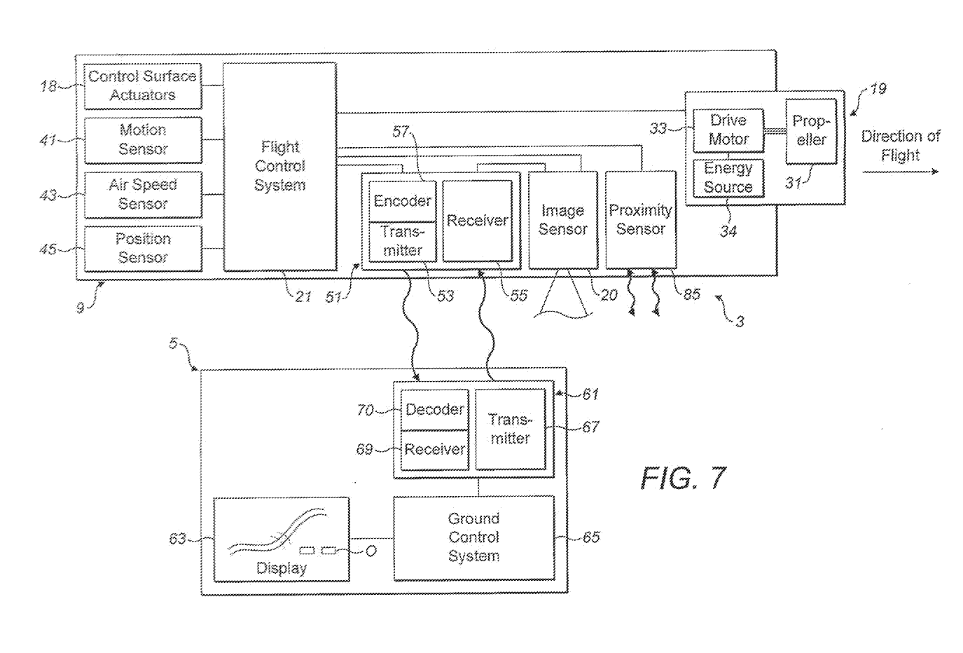

FIG. 7 illustrates an unmanned air vehicle (UAV) control system in accordance with a second embodiment of the present invention.

FIGS. 1 to 4 illustrate an unmanned air vehicle (UAV) control system in accordance with a first embodiment of the present invention.

As illustrated in FIGS. 1 and 2, the unmanned air vehicle (UAV) control system comprises an unmanned air vehicle (UAV) 3 and a ground station 5 for controlling operation of the UAV 3, retrieving/visualising object data and providing data to a user for sense-and-avoid functionality, as will be described in more detail below.

FIGS. 3(a) to (d) illustrate a UAV 3 in accordance with a first embodiment of the present invention.

The UAV 3 comprises an airframe 9, which comprises a fuselage 11 and wings 15 which extend from the fuselage 11 and include control surfaces 17 and associated control surface actuators 18 for operating the same, a propulsion device 19 for propelling the UAV 3 in flight, an image sensor 20 for imaging ground-based objects O, and a flight control system 21 for controlling the in-flight operation of the UAV 3.

In this embodiment the airframe 9 is neutrally stable, that is, has no natural stability or is unstable, and the flight control system 21 is configured to render the UAV 3 gust insensitive, whereby the UAV 3 exhibits substantially only linear translational (longitudinal, lateral and vertical) displacements and little or no rotational (yaw, pitch and roll) displacements as wind gusts are encountered.

Neutrally stability is achieved by arranging the center of gravity of the UAV 3 and the positions of the wings 15 such that wind gusts do not induce moments about any axis of the UAV 3. The absence of gust-induced moments removes any tendency to develop angular displacements when wind gusts are encountered.

By virtue of the UAV 3 being gust insensitive, and providing only for linear displacements of the UAV 3, the image sensor 20 can have a fixed position to the airframe 9, avoiding the need for a complex gimbal system, as linear displacements disrupt the image from the image sensor 20 to a much smaller extent than angular displacements, allowing a simple, fixed sensor arrangement to produce a usable image.

In this embodiment the fuselage 11 comprises an elongate structure.

In this embodiment the airframe 9 comprises at least three, here four wings which are arranged in symmetrical relation about the fuselage 11, here in cross (X) formation.

In this embodiment the wings 15 are forwardly swept in the direction of flight. In an alternative embodiment the wings 15 could be rearwardly swept in the direction of flight.

This symmetrical configuration of the wings 15 confers the UAV 3 with roll stability about the longitudinal axis of the fuselage 11, which, through operation of the control surfaces 17, allows for the roll angle of the UAV 3 to be set to any angle as required. As will be discussed in more detail hereinbelow, the ability to control the roll angle of the UAV 3, in combination with the gust insensitivity of the UAV 3, enables the image sensor 20 to have a fixed position.

In an alternative embodiment the airframe 9 could further comprise a tall section.

In this embodiment the propulsion device 19 is operative to generate a propulsion air flow, here a high-speed air flow, which acts to propel the UAV 3 in flight.

In this embodiment the propulsion device 19 is located forwardly of the wings 15 in the direction of flight, such that the propulsion air flow is directed over the control surfaces 17 of the wings 15, enabling a fast control response even when the UAV 3 does not have a high velocity, in particular during a vertical take-off.

In an alternative embodiment the propulsion device 19 could be located rearwardly of the wings 15 in the direction of flight.

In this embodiment the propulsion device 19 comprises a propeller 31 and a drive motor 33, powered by an energy source 34, here battery cells.

In an alternative embodiment the propulsion device 19 could comprise a jet, powered by a fuel source, and in a preferred embodiment the jet propulsion device 19 includes lateral jet ducts which are selectively operable to control stability of the UAV 3, particularly when operating at low speeds.

In this embodiment the UAV 3 includes an image sensor 20, here a video image sensor, which is capable of imaging a footprint on the ground, and in particular an object O on the ground.

In this embodiment the UAV 3 includes a single image sensor 20, which has a fixed position in relation to the airframe 9.

In this embodiment the image sensor 20 faces radially outwardly, such that the position of the sensor footprint can be adjusted by controlling the pitch, roll and heading of the UAV 3, where the roll angle can be set to have any required angle, independent of the pitch and heading of the UAV 3.

In one embodiment the image sensor 20 could include a plurality of sensor elements arranged fore-to-aft to allow for the simultaneous acquisition of images at different fore-aft elevations.

In an alternative embodiment the image sensor 20 could include a single sensor element and an actuator for altering the fore-aft elevation of the sensor element.

The flight control system 21 comprises a motion sensor 41, in this embodiment an inertial/motion sensor incorporating accelerometers and gyros, for providing orientation measurements, including pitch angle, roll angle and heading of the UAV 3, and inertial measurements, including acceleration and angular rate of the UAV 3.

The flight control system 21 further comprises an air speed sensor 43 for sensing the speed of the UAV 3.

The flight control system 21 further comprises a position sensor 45, in this embodiment a GPS receiver, for sensing the latitude, longitude and height of the UAV 3.

In operation, the flight control system 21, under the control of flight control software, senses the motion of the UAV 3 using the flight control sensors 41, 43, 45 and moves the control surfaces 17 using the control surface actuators 18 to maintain the UAV 3 on a desired trajectory. As the UAV 3 has a neutral trim state and no natural stability, which would tend to return an aircraft to its original flight speed and direction once perturbed by a wind gust, flight control requires the sensing of the motion of the UAV 3 to be very rapid and the movement of the control surfaces 17 to be both very rapid and accurate, in a manner which would be impossible for a human pilot to perform over any significant period of time. Whilst such flight control would be impossible for a human pilot, the present invention allows for such flight control, in that the sensing and the actuator response is performed under the control of the flight control system 21.

The present invention allows for a number of different flight modes, which include:

### (I) Orbit

In this mode, the control algorithm holds the UAV 3 in an orbit, typically an elliptical orbit, about the object O to steer the UAV 3 such that the object O is kept in view of the image sensor 20. The control algorithm calculates the pitch, roll and heading required to hold the required orbit and maintain the sensor footprint on the object O.

### (II) Waypoint

In this mode, the control algorithm navigates the UAV 3 around a set of waypoints to keep the object O in view of the image sensor 20 as much as possible. The control algorithm calculates the pitch, roll and heading required to maintain the sensor footprint on the object O in following the waypoint sequence.

### (III) Home to Object

In this mode, the control algorithm navigates the UAV 3 repeatedly to over-fly the object O and point the image sensor 20 to maintain the object O in the sensor footprint as much as possible. The control algorithm calculates the pitch, roll and heading required to maintain the sensor footprint on the object O in flying directly over the object O and the distance to fly away from the object O before initiating a turn-back to the object O.

### (IV) Footprint Steering

In this mode, the control algorithm navigates the UAV 3 to “fly” the sensor footprint along a given line of search, for example, in order to map a desired zone. The control algorithm navigates the UAV 3 such that the center of the sensor footprint travels along the required line of search regardless of the wind.

The UAV 3 further comprises a communications module 51 for communicating with the ground station 5.

In this embodiment the communications module 51 comprises a transmitter 53 for transmitting video signals and telemetry data to the ground station 5, and a receiver 55 for receiving control signals from the ground station 5.

In this embodiment, in transmitting telemetry information from the UAV 3 to the ground station 5, digital telemetry data is encoded into the blanking lines of a standard PAL video signal.

In this embodiment the transmitter 53 includes an encoder 57 which receives a video signal from the image sensor 20 and telemetry data from the flight control sensors 41, 43, 45, and encodes the telemetry data into the blanking lines of the video signal to provide a combined signal. As the digital telemetry data is superimposed on a section of video during the vertical blanking period, the telemetry data does not intrude on the visible picture.

In this embodiment the encoder 57 combines a standard 625 line System I video signal, with optional PAL color encoding, standard DRA bi-phase 4096 bits per second, 32 channel telemetry and 9600 baud serial data (GPS) onto a single video signal.

In this embodiment the encoder 57 comprises an encoder card which generates the video timing signals and data stream, and a mixer unit which receives the video timing signals and data stream, converts the same into video levels and mixes the same into the video source.

The ground station 5 comprises a communications module 61 for communicating with the UAV 3, a display 63 for displaying the video image from the image sensor 20 on board the UAV 3, and a ground control system 65 for controlling operation of the UAV 3, driving the display 63 to display the video image from the image sensor 20 on board the UAV 3 and providing a user interface to enable identification of an object O in a displayed image.

In this embodiment the communications module 61 comprises a transmitter 67 for transmitting telemetry data to the UAV 3, and a receiver 69 for receiving video signals and telemetry data from the UAV 3.

In this embodiment the receiver 69 includes a decoder 70 which separates the telemetry data from the combined signal received from the UAV 3, and separately provides the telemetry data and a video signal, which can be displayed on a standard, unmodified video monitor.

In this embodiment the ground control system 65 includes a user interface, which allows a user to identify an object O in the image displayed on the display 63, and determine the position thereof, including the latitude, longitude and height.

In determining the position of the object O, the ground control system 65 utilizes object position determining technology, which represents an advanced form of triangulation, to determine the position of the object O, including height, without the use of digital terrain data. This technology allows the UAV 3 to be used in unmapped or poorly-mapped areas and is suitable for static or slow-moving ground-based objects O.

In calculating the actual position of the object O on the ground using the screen co-ordinates of the image of the object O on the display 63, the following information is required:

From telemetry:
UAV 3 position, including:
   Latitude
   Longitude
   Height above a reference height RH
UAV 3 orientation, including:
   Pitch angle
   Roll angle
   Heading
Image sensor orientation (which may be constant) with respect to aircraft, including:
   Roll
   Elevation
   Azimuth

From the screen image:
X and Y position of the object O

In this embodiment the object positioning determining technology employs repeated object position finding from different positions of the UAV 3, and determines the position of the object O relative to a reference height RH for the UAV 3 from the plurality of object fixes, which assumes that the object O has not moved between fixes.

FIGS. 4(a) and (b) illustrate a circumstance where the UAV 3 is on a track approaching an object O which is at a height H above the reference height RH for the UAV 3, and the apparent position of the object O is determined from a plurality of object fixes Fix1, Fix2. FIG. 4(a) illustrates an elevational view where the UAV 3 is approaching the object O, and FIG. 4(b) illustrates a plan view where the UAV 3 is on a heading lateral to the object O.

At the first fix Fix 1, the system calculates an apparent position of the object O. In the case illustrated, this gives an object position too distant from the UAV 3. At the second fix Fix 2, the apparent position of the object O has changed, in this case moved towards the UAV 3 and on a different heading. The change in position is a function of the height error, allowing the height error to be calculated from the apparent change in position of the object O. From this height error, an accurate position, including height, of the object O is determined.

The use of this technique is combined with advanced trajectory shaping, which allows the operator to select an object O, using point and click in the Image sensor view, at the ground station 5. Through the use of the described navigation algorithms, the vehicle trajectory and attitude are optimised in order to maintain the object O within the field of view of the image sensor 20, maximising “time on object”. This facility has a major advantage in deskilling the operation of the UAV 3, providing carefree handling and allowing the operator to focus on the retrieval of data from the sensor payload, rather than direct control of the flight pattern of the UAV 3.

If digital terrain data is available, then, using an iterative method, it is possible to use an initial estimate of the height above the object O and determine a more accurate height above the object O and hence a more accurate position. This is similar to the operator identifying the position of the object O on a topographical map, estimating the height of the object O from the map data and inputting this information to the system.

FIG. 5 schematically represents the UAV 3 and the ground station 5 of a UAV control system as a modification of the UAV control system of the above-described embodiment.

The UAV control system of this embodiment differs in that the UAV 3 includes a second, forward-looking image sensor 71, here a video image sensor, which provides an operator with a visual image of the flying environment ahead of the UAV 3, and the ground station 5 includes a second display 72 for displaying the video image from the forward-looking image sensor 71, with the video signals from the forward-looking image sensor 71 being transmitted to the ground station 5 by the transmitter 53 of the communications module 51.

In this embodiment the forward-looking image sensor 71 is supported in a gimbal support 73, here a single-axis gimbal support, which enables, in the event that another air vehicle is identified ahead of the UAV 3 and evasive action is required, the forward-looking image sensor 71 to maintain the other air vehicle in view during the evasive action.

The maintenance of this visual contact using only a single-axis gimbal support 73 is possible by the ability to roll the UAV 3 to any attitude and still achieve lateral manoeuvring of the UAV 3; there being no skidding as the UAV 3 is able to generate a wing-borne force in any direction without rolling.

This concept utilises the ability to control the UAV 3 attitude in roll, pitch and yaw, whilst maintaining forward flight, to scan the sky and achieve a sense and avoid function similar to a human pilot, though the significant difference with a conventional air vehicle, which normally avoids an approaching air vehicle by banking to turn and compromises the visual on the approaching air vehicle, is that the visual on the approaching air vehicle is not compromised. In this instance, the pilot could be on the ground performing a remotely-piloted vehicle roll with conventional stick control, although there may be other options. However, instead of directly and consciously controlling the attitude or flightpath of the UAV 3, the pilot would be controlling the viewpoint of the returned image, in effect “flying the image sensor”. This would allow the pilot to scan the sky ahead, to achieve the sensing role, by effectively yawing the aircraft and to a more limited degree, pitching the aircraft.

FIGS. 6(a) to (d) illustrate a UAV 3 in accordance with a second embodiment of the present invention.

The UAV 3 of this embodiment is quite similar to the UAV 3 of the first-described embodiment, and thus, in order to avoid unnecessary duplication of description, only the differences will be described in detail, with like parts being designated by like reference signs.

The UAV 3 of this embodiment differs from that of the first-described embodiment in that the wings 15 are rearwardly swept in the direction of flight, and in comprising strengtheners 81 at the tips of the wings 15, which allow the UAV 3 to rest directly on the ground.

In an alternative embodiment the wings 15 could be forwardly swept.

In this embodiment, similarly to the first-described embodiment, the propulsion device 19 is located forwardly of the wings 15 in the direction of flight, such that the propulsion air flow is directed over the control surfaces 17 of the wings 15, enabling a fast control response even when the UAV 3 does not have a high velocity, in particular during a vertical take-off.

In an alternative embodiment the propulsion device 19 could be located rearwardly of the wings 15 in the direction of flight.

In this embodiment, similarly to the first-described embodiment, the propulsion device 19 comprises a propeller 31 and a drive motor 33, powered by an energy source 34, here battery cells.

In an alternative embodiment the propulsion device 19 could comprise a jet, powered by a fuel source, and in a preferred embodiment the jet propulsion device 19 includes lateral jet ducts which are selectively operable to control stability of the UAV 3, particularly when operating at low speeds.

In an alternative embodiment, similarly to the first-described embodiment, the airframe 9 could further comprise a tail section.

FIG. 7 illustrates an unmanned air vehicle (UAV) control system in accordance with a second embodiment of the present invention.

The UAV control system of this embodiment is a modification of the first-described UAV control system, and thus, in order to avoid unnecessary duplication of description, only the differences will be described in detail, with like parts being designated by like reference signs.

In this embodiment the UAV 3 includes a proximity sensor 85 for sensing the proximity of physical structures, here fixed physical structures, which can be closely confined, such as presented by narrow tracks, through which the UAV 3 has to be navigated, or arrays of obstructions, around which the UAV 3 has to be navigated, and the flight control system 21 is operative automatically to navigate the UAV 3 utilizing the input from the proximity sensor 85, in a preferred embodiment at a fixed height.

In this embodiment the proximity sensor 85 comprises one or more sensor units, here utilizing electromagnetic radiation. In this embodiment the proximity sensor 85 comprises one or more radar sensor units, but alternatively or additionally could comprise one or more infra-red sensor units, one or more laser sensor units or one or more acoustic sensor units.

The present inventor has recognized that the UAV 3 allows for use in particularly confined environments, which would not be possible using conventional aircraft, manned or unmanned, through utilisation of the proximity sensor 85 to provide navigational control inputs. The UAV 3 has the ability to turn in any direction, independent of roll angle, unlike conventional aircraft which have to roll to turn, and thus the UAV 3 is able to respond instantly to navigational control inputs, providing an extremely agile vehicle, and, by utilising the proximity sensor 85 to provide navigational control inputs, the UAV 3 is able to navigate in particularly confined environments, which would otherwise not be possible. This navigational control is enhanced by operating the UAV 3 in a gust-insensitive mode, as confined environments are particularly sensitive to gusts.

Finally, it will be understood that the present invention has been described in its preferred embodiments and can be modified in many different ways without departing from the scope of the invention as defined by the appended claims.

1. A gust-insensitive unmanned air vehicle (UAV) for imaging the ground, the UAV comprising:
an airframe which is substantially neutrally stable and comprises a fuselage and at least three wings which include control surfaces, wherein the wings are arranged in symmetrical relation about the fuselage and confer the UAV with a roll stability about the longitudinal axis of the fuselage for any roll angle, thereby allowing the roll angle of the UAV to be set to any required angle independent of the heading and pitch angle of the UAV;
a propulsion device for propelling the UAV in flight;
an image sensor for imaging the ground, wherein the image sensor has a footprint, the position of which is determined by the roll angle of the UAV; and
a flight control system for controlling the in-flight operation of the UAV, wherein the flight control system includes flight control sensors and is operative to render the UAV gust insensitive in response to inputs from the flight control sensors, whereby the UAV exhibits substantially only linear displacements in response to wind gusts, and control the roll angle of the UAV to determine the position of the sensor footprint.

2. The UAV of claim 1, wherein the airframe comprises four wings which are arranged in cross (X) formation, wherein the wings are forwardly swept in the direction of flight of the UAV.

3. (canceled)

4. The UAV claim 1, wherein the propulsion device is operative to generate a propulsion air flow, which acts to propel the UAV in flight, and wherein the propulsion device is located forwardly of at least part of the wings in the direction of flight of the UAV, such that the propulsion air flow is directed over the control surfaces of the wings, and wherein the propulsion device comprises a propeller and a drive motor which drives the propeller, or a jet.

5. (canceled)

6. (canceled)

7. The UAV of claim 1, wherein the image sensor has a fixed position in relation to the airframe, and wherein the image sensor includes one or more sensor elements.

8. (canceled)

9. (canceled)

10. The UAV of claim 1, wherein the image sensor is movable only in a single axis in relation to the airframe.

11. (canceled)

12. The UAV of claim 1, wherein the flight control system comprises a motion sensor for sensing motion of the UAV, preferably the motion sensor provides orientation measurements, including pitch angle, roll angle and heading of the UAV, and inertial measurements, including acceleration and angular rate of the UAV.

13. The UAV of claim 1, wherein the flight control system comprises an air speed sensor for sensing the speed of the UAV.

14. The UAV of claim 1, wherein the flight control system comprises a position sensor for sensing the latitude, longitude and height of the UAV, preferably the position sensor comprises a GPS receiver.

15. The UAV of claim 1, wherein the flight control system comprises a proximity sensor for sensing proximity of physical structures, through or around which the UAV is to be navigated, and the flight control system is operative automatically to navigate the UAV utilizing control inputs from the proximity sensor, at a fixed height, and wherein the proximity sensor comprises one or more sensor units, one or more radar sensor units, one or more infra-red sensor units, one or more laser sensor units or one or more acoustic sensor units.

16. (canceled)

17. (canceled)

18. An unmanned air vehicle (UAV) control system for imaging the ground, the UAV control system comprising:
the UAV of claim 1, further comprising:
a communications module for communicating with a ground station; and
a ground station for controlling operation of the UAV, wherein the ground station comprises:
a communications module for communicating with the UAV; and
a ground control system for controlling operation of the UAV.

19. (canceled)

20. The UAV control system of claim 18, wherein the communications module of the UAV comprises a transmitter for transmitting video signals and telemetry data to the ground station and a receiver for receiving telemetry data from the ground station, and the communications module of the ground station comprises a transmitter for transmitting telemetry data to the UAV and a receiver for receiving video signals and telemetry data from the UAV, and wherein the transmitter of the communications module of the UAV includes an encoder which receives a video signal from the image sensor and telemetry data from the flight control sensors, and encodes the telemetry data into blanking lines of the video signal to provide a combined signal, and the receiver of the communications module of the ground station includes a decoder which separates the telemetry data from the combined signal, and separately provides the telemetry data and a video signal, and wherein the encoder comprises an encoder card which generates video timing signals and a data stream, and a mixer unit which receives the video timing signals and data stream, converts the same into video levels and mixes the same into the combined signal.

21. (canceled)

22. (canceled)

23. The UAV control system of claim 18, wherein the UAV is operable in a plurality of different flight modes, wherein the UAV is operable in an orbit mode, in which the UAV is held in an orbit about an object on the ground, such that the sensor footprint is maintained over the object, and wherein the UAV is operable in a waypoint mode, in which the UAV is navigated around a set of waypoints, such that the sensor footprint is maintained on an object, and wherein the UAV is operable in an over-fly mode, in which the UAV is repeatedly navigated to over-fly an object, such that the sensor footprint is, where possible, maintained on the object, and wherein the UAV is operable in a search mode, in which the UAV is navigated to maintain the sensor footprint along a given line of search.

24-27. (canceled)

28. The UAV control system of claim 18, wherein the ground control system includes a user interface, which allows a user to identify an object in the image displayed on a display, and determine the position thereof, including the latitude, longitude and height, wherein the ground control system is operative to determine the position, including height, of the identified object, without the use of digital terrain data, and wherein the ground control system, in determining the position of the identified object, fixes the position of the identified object from a plurality of different positions of the UAV based on a reference height, and determines the position of the identified object relative to the reference height for the UAV from the plurality of object fixes, and wherein the ground control system determines the position of the identified object from the intersection of imaginary lines, for each object fix, from the UAV to the object.

29-31. (canceled)

32. The UAV control system of claim 18, wherein the UAV further comprises:
a second, forward-looking image sensor for imaging air space ahead of the UAV in flight, wherein the second image sensor is movable in only a single axis, and wherein the ground control system is operable, through control of the roll angle of the UAV and movement of the second image sensor, to scan the air space ahead of the UAV.

33-53. (canceled)

54. A gust-insensitive unmanned air vehicle (UAV) for imaging the ground, the UAV comprising:
an airframe which is neutrally stable and comprises a fuselage and wings which include control surfaces;
a propulsion device for propelling the UAV in flight;
an image sensor for imaging the ground, wherein the image sensor has a footprint, the position of which is determined by the orientation of the UAV; and
a flight control system for controlling the in-flight operation of the UAV, wherein the flight control system includes flight control sensors and is operative to render the UAV gust insensitive in response to inputs from the flight control sensors, whereby the UAV exhibits substantially only linear displacements in response to wind gusts.

55. The UAV of claim 54, wherein the airframe comprises four wings which are arranged in cross (X) formation, wherein the wings are forwardly swept in the direction of flight of the UAV.

56-70. (canceled)

71. An unmanned air vehicle (UAV) control system for imaging the ground, the UAV control system comprising:
an unmanned air vehicle (UAV) including an image sensor for imaging the ground, the image sensor having a footprint, the position of which is determined by the orientation of the UAV, and a communications module for communicating with a ground station; and
a ground station for controlling operation of the UAV, the ground station comprising a communications module for communicating with the UAV, and a ground control system for controlling operation of the UAV.

72. (canceled)

73. The UAV control system of claim 71, wherein the communications module of the UAV comprises a transmitter for transmitting video signals and telemetry data to the ground station and a receiver for receiving telemetry data from the ground station, and the communications module of the ground station comprises a transmitter for transmitting telemetry data to the UAV and a receiver for receiving video signals and telemetry data from the UAV, and the transmitter of the communications module of the UAV includes an encoder which receives a video signal from the image sensor and telemetry data from flight control sensors, and encodes the telemetry data into blanking lines of the video signal to provide a combined signal, and the receiver of the communications module of the ground station includes a decoder which separates the telemetry data from the combined signal, and separately provides the telemetry data and a video signal.

74. (canceled)

75. The UAV control system of claim 73, wherein the encoder comprises an encoder card which generates video timing signals and a data stream, and a mixer unit which receives the video timing signals and data stream, converts the same into video levels and mixes the same into the combined signal.

76-96. (canceled)

97. A method of operating an unmanned air vehicle (UAV), the method comprising the steps of:
providing an unmanned air vehicle (UAV), wherein the UAV has an airframe which is substantially neutrally stable and comprises a fuselage and at least three wings which include control surfaces, wherein the wings are arranged in symmetrical relation about the fuselage and confer the UAV with a roll stability about the longitudinal axis of the fuselage for any roll angle, thereby allowing the roll angle of the UAV to be set to any required angle independent of the heading and pitch angle of the UAV, and comprising a flight control system for controlling the in-flight operation of the UAV, wherein the flight control system includes flight control sensors and a proximity sensor for sensing proximity of physical structures, through or around which the UAV is to be navigated; and
automatically navigating the UAV utilizing control inputs from the flight control sensors and the proximity sensor, preferably at a fixed height, and rendering the UAV gust insensitive in response to inputs from the flight control sensors, whereby the UAV exhibits substantially only linear displacements in response to wind gusts.
